(19) United States
(12) Patent Application Publication
(10) Pub. No.: US 2026/0300719 A1
(43) Pub. Date: Oct. 1, 2026

(54) METHOD AND DEVICE FOR TRAINING LARGE MODEL BASED ON INTELLIGENT OPTICAL COMPUTING, AND STORAGE MEDIUM

(71) Applicant: TSINGHUA UNIVERSITY, BEIJING (CN)

(72) Inventors: LU FANG, BEIJING (CN); ZHIWEI XUE, BEIJING (CN)

(21) Appl. No.: 19/346,546

(22) Filed: Sep. 30, 2025

(30) Foreign Application Priority Data
Mar. 28, 2025 (CN) 202510379731.X

(51) Int. Cl. G06N 3/08; G06N 3/04; G06N 3/067

(52) U.S. Cl. CPC G06N 3/08; G06N 3/04; G06N 3/0675

(57) ABSTRACT

A method for training a large model based on intelligent optical computing performed by an electronic device includes: obtaining a training data set and obtaining a prediction result by inputting data in the training data set into a preset large model including a multi-layer perceptron layer that includes at least one optical module layer; determining, based on the prediction result and a real result, a target loss value via a target loss function; determining a first loss gradient corresponding to the multi-layer perceptron layer by performing backpropagation based on the target loss value; determining a second loss gradient of each optical module layer based on the first loss gradient; and updating parameters of each optical module layer based on the second loss gradient of each optical module layer, and obtaining a target large model by repeating the above steps until the preset large model is converged.

### CROSS-REFERENCE TO RELATED PATENT APPLICATION

This application claims priority to Chinese Patent Application No. 202510379731.X, filed on Mar. 28, 2025, the entire content of which is incorporated by reference herein.

### FIELD OF THE DISCLOSURE

The disclosure relates to the field of optical computing technology, and in particular to a method for training a large model for intelligent optical computing, an electronic device, and a storage medium.

### BACKGROUND OF THE DISCLOSURE

With the development of deep learning and a large model, the computational complexity and scale requirements for a training process of the large model are continuously increasing. However, there are challenges such as high power consumption and computational delay when large-scale parallel computing tasks are processed in the existing electronic computing architecture, which is difficult to effectively meet the increasingly stringent demands of the large model for computing power and power efficiency. Optical computing, which utilizes photons for information transmission and processing, offers advantages of ultra-high speed and low energy consumption. Consequently, optical computing technology where electrons are replaced with photons as the computing carrier is regarded as a key point to break through the existing computational bottlenecks.

### SUMMARY OF THE DISCLOSURE

According to a first aspect of the disclosure, a method for training a large model based on intelligent optical computing is performed by an electronic device. The method includes: obtaining a training data set and obtaining a prediction result by inputting data in the training data set into a preset large model, in which the preset large model includes a multi-layer perceptron layer, and the multi-layer perceptron layer includes at least one optical module layer; determining, based on the prediction result and a real result, a target loss value via a target loss function; determining a first loss gradient corresponding to the multi-layer perceptron layer by performing backpropagation based on the target loss value; determining a second loss gradient of each optical module layer based on the first loss gradient; and updating parameters of each optical module layer based on the second loss gradient of each optical module layer, and obtaining a target large model by repeating the above steps until the preset large model is converged.

According to a second aspect of the disclosure, an electronic device includes: at least one processor; and a memory communicatively coupled to the at least one processor and storing instructions executable by the at least one processor; in which when the instructions are executed by the at least one processor, the at least one processor is caused to perform the method according to the above first aspect.

According to a third aspect of the disclosure, a non-transitory computer storage medium has stored computer-executable instructions which, when executed by a processor, enable the method according to the above first aspect to be implemented.

### BRIEF DESCRIPTION OF THE DRAWINGS

The above-mentioned and/or additional aspects and advantages of the disclosure will become apparent and readily appreciated from the following description of embodiments, taken in combination with the accompanying figures.

FIG. 1 is a flow chart illustrating a method for training a large model for intelligent optical computing provided in an embodiment of the disclosure.

FIG. 2 is a block diagram illustrating a structure of a system for training a large model for intelligent optical computing provided in an embodiment of the disclosure.

FIG. 3 is a block diagram illustrating an electronic device according to some embodiments of the present disclosure.

### DETAILED DESCRIPTION OF THE EXEMPLARY EMBODIMENTS

Embodiments of the disclosure are described in detail below, and examples of the embodiments are illustrated in the accompanying figures, in which the same or similar symbols from beginning to end indicate the same or similar elements. The embodiments described below by reference to the accompanying figures are exemplary and are intended to be used to explain the disclosure and are not to be construed as a limitation of the disclosure.

The disclosure is described in detail below with reference to specific embodiments.

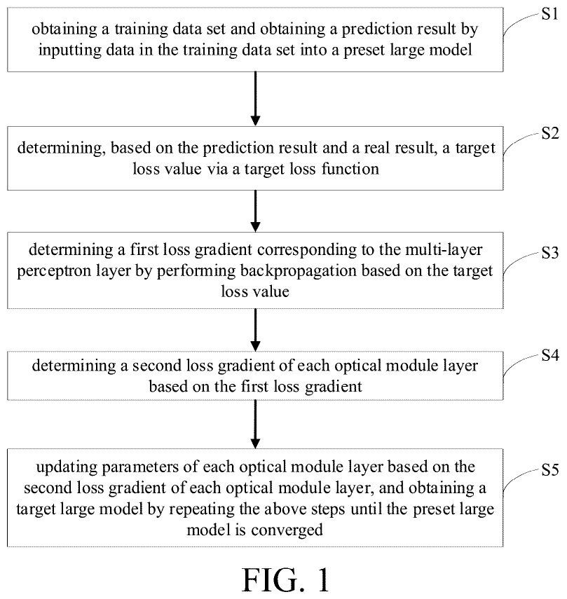

FIG. 1 is a flow chart illustrating a method for training a large model for intelligent optical computing provided in an embodiment of the disclosure. As shown in FIG. 1, the method may include the following steps S1 to S5. In embodiments of the disclosure, the method may be performed by an electronic device.

At step S1, a training data set is obtained and a prediction result is obtained by inputting data in the training data set into a preset large model.

At step S2, a target loss value via a target loss function is determined based on the prediction result and a real result.

At step S3, a first loss gradient corresponding to the multi-layer perceptron layer is determined by performing backpropagation based on the target loss value.

At step S4, a second loss gradient of each optical module layer is determined based on the first loss gradient.

At step S5, parameters of each optical module layer are updated based on the second loss gradient of each optical module layer, and a target large model is obtained by repeating the above steps until the preset large model is converged.

In an embodiment of the disclosure, the large model may be applied to various scenarios, such as an intelligent question answering scenario.

In an embodiment of the disclosure, the large model may include the multi-layer perceptron layer. The large model may include one or more multi-layer perceptron layers, which is not limited in the embodiments of the disclosure.

Further, in an embodiment of the disclosure, the multi-layer perceptron layer is a trainable module, that is, parameters of the multi-layer perceptron layer are fully reconfigurable. Due to the high parallelism and high throughput characteristics of optical computing, a high-dimensional multi-layer perceptron may be partitioned into a plurality of parallel low-dimensional multi-layer perceptron structures. That is, the multi-layer perceptron layer is partitioned into at least one optical module layer. This leverages the highly parallel computing characteristics of optical computing, enabling highly parallel online training to be performed synchronously on each optical module layer, thus increasing the training speed of the multi-layer perceptron.

In an embodiment of the disclosure, for each multi-layer perceptron layer, a fully forward training method may be adopted for training. For example, in an embodiment of the disclosure, a multi-layer perceptron with an input of N×N may be partitioned into a combination of N optical modules. Specifically, for a multi-layer perceptron, its input is x and its output is y, in which y=Wx is satisfied, where W=[m₁, m₂, . . . , mₙ], mᵢ ∈ R^{N}, W ∈ R^{N×N}. This is transformed into a combination of N optical modules, i.e.,

$$y = {\sum }_{i}^{N} {A}_{i} ( {m}_{i} \cdot {x}_{i} ) ,$$

where xᵢ is an input of the i-th optical module, Aⱼ(mᵢ·xᵢ) is an output of the i-th optical module, and

$${A}_{i} = [ \begin{matrix}1 & 1 & … & 1 \\ 1 & 0 & … & 0 \\ … & … & … & … \\ 1 & 0 & … & 0\end{matrix} ] .$$

The i-th row and i-th column are all 1, and the remaining elements are all 0. Thus, the partitioned N optical modules are completely equivalent to an ordinary multi-layer perceptron. In this case, training the multi-layer perceptron may be completed by training N combined optical modules.

Further, in an embodiment of the disclosure, the method for obtaining the prediction result by inputting the data in the training data set into the preset large model may include the following steps S11 to S13.

At step S11: input data of the multi-layer perceptron layer is obtained, and first output data of each optical module layer is obtained by inputting the input data into each optical module layer in parallel.

At step S12: second output data of the multi-layer perceptron layer is obtained by merging the first output data of each optical module layer.

At step S13: the second output data is input into a next network layer for the multi-layer perceptron layer, and an output result of a last network layer in the large model is determined as the prediction result.

In an embodiment of the disclosure, the method for merging the first output data of each optical module layer may refer to the description about

$$y = {\sum }_{i}^{N} {A}_{i} ( {m}_{i} \cdot {x}_{i} ) .$$

Further, in an embodiment of the disclosure, each optical module layer includes at least one network sub-layer. For example, in an embodiment of the disclosure, each optical module layer can include an activation layer and a propagation layer.

In an embodiment of the disclosure, the method for determining the second loss gradient of each optical module layer based on the first loss gradient may include: determining a third loss gradient of each network sub-layer in each optical module layer based on the first loss gradient; and determining the third loss gradients of all network sub-layers in each optical module layer as the second loss gradient of each optical module layer.

In an embodiment of the disclosure, the forward propagation of the large model during training may be represented as:

$${y}_{k} ( {r}_{o} ) = \int {G}_{k} ( {r}_{o} , {r}_{i} ) {x}_{k} ( {r}_{i} ) d ( {r}_{i} ) ,$$

where, rᵢ is a position vector of a point in the input plane, representing the position of the point in three-dimensional space; rₒ is a position vector of a point in the output plane, representing the position of the point in three-dimensional space; Gₖ(rₒ, rᵢ) is the Green's function from rᵢ to rₒ, acting as a transfer function; Xₖ(rᵢ) is an input value at point rᵢ. The output Xₖ₊₁=f(yₖ) may be transmitted to subsequent layers by a nonlinear activation layer.

Further, in an embodiment of the disclosure, a loss function L=ψ(y_{N}, T) may be evaluated based on the prediction result, where y_{N} is a prediction result and T is a real result. To effectively evaluate the loss, the loss function L may be used to compute the first loss gradient yN corresponding to the multi-layer perceptron layer as:

$$δ {y}_{N} = \frac{\partial L}{\partial {y}_{N}} = {Ψ}_{x}^{′} ( {y}_{N} , T )$$

Further, in an embodiment of the disclosure, after obtaining the first loss gradient through the above steps, the third loss gradient of each network sub-layer in each optical module layer may be determined based on the first loss gradient. In an embodiment of the disclosure, the method for determining the third loss gradient of each network sub-layer in each optical module layer based on the first loss gradient may include: determining a fourth loss gradient of each network sub-layer in each optical module layer by differentiating the first loss gradient based on a chain rule; and obtaining the third loss gradient of each network sub-layer in each optical module layer by processing the fourth loss gradient of each network sub-layer based on Lorentz reciprocity.

In an embodiment of the disclosure, the fourth loss gradient of each network sub-layer determined by differentiating the first loss gradient based on the chain rule is:

$${δ}_{{x}_{k}} ( {r}_{i} ) = \int {δ}_{{y}_{k}} ( {r}_{o} ) \frac{\partial {y}_{k} ( {r}_{0} )}{\partial {x}_{k} ( {r}_{i} )} d ( {r}_{o} ) = \int {G}_{k} ( {r}_{o} , {r}_{i} ) {δ}_{y} ( {r}_{o} ) d ( {r}_{o} )$$

In an embodiment of the disclosure, the third loss gradient of each network sub-layer in each optical module layer obtained by processing the fourth loss gradient of each network sub-layer based on Lorentz reciprocity is:

$${δ}_{{x}_{k}} ( {r}_{i} ) = \int {G}_{k} ( {r}_{i} , {r}_{o} ) {δ}_{y} ( {r}_{o} ) d ( {r}_{o} ) ,$$

where Gₖ(rₒ, rᵢ)=Gₖ(rᵢ, rₒ) is obtained base on the Lorentz reciprocity, let Gₖ(rₒ, rᵢ) to be replaced with Gₖ(rᵢ, rₒ) to obtain the third loss gradient for each network sub-layer.

It should be noted that, in an embodiment of the disclosure, the complexity of backpropagation in gradient algorithms may hinder the training of general systems. To adapt to a free space and an integrated optical system, the optical system may be trained via forward propagation. This requires proving that, in the case of spatial symmetry, data and error propagation may share the same forward path.

In a mirror-symmetric system, G(rᵢ, rₒ)=G(σᵥ(rᵢ), σᵥ(rₒ)), where σᵥ(rᵢ), σᵥ(rₒ) are position vectors of a corresponding point obtained after mirror symmetry of rᵢ within the system, let

$$( {r}_{o}^{′} , {r}_{i}^{′} ) = ( {σ}_{v} ( {r}_{i} ) , {σ}_{v} ( {r}_{o} ) ) ,$$

which achieves a one-to-one correspondence between (rᵢ, rₒ) and

$$( {r}_{o}^{′} , {r}_{i}^{′} ) .$$

Further, there is

$$( {r}_{o}^{′} , {r}_{i}^{′} )$$

for each (rᵢ, rₒ), and let

$$G ( {r}_{i} , {r}_{o} ) = G ( {r}_{o}^{′} , {r}_{i}^{′} ) . {δ}_{{x}_{k}} ( {r}_{o}^{′} ) = \int d ( {r}_{i}^{′} ) {G}_{k} ( {r}_{o}^{′} , {r}_{i}^{′} ) {δ}_{y} ( {r}_{i}^{′} )$$

is obtained by introducing

$$( {r}_{o}^{′} , {r}_{i}^{′} )$$

in the above-mentioned process of forward propagation, which is equivalent to providing δ_{y} at the input end of the system and propagating δ_{y} forward to the output end of the system.

In a rotationally symmetric system C_{Nv}, it is assumed that the input and output of the system have an integer rotational symmetry relationship, i.e., there is

$${r}_{o}^{′} = R ( {r}_{i} ) ∈ {Ω}_{o u t}$$

for any input point rᵢ ∈ Ωᵢₙ. Conversely, there is

$${r}_{i}^{′} = {R}^{- 1} ( {r}_{o} ) ∈ {Ω}_{i n}$$

for any output point rₒ ∈ Ωₒᵤₜ

$$Let ( {r}_{o}^{′} , {r}_{i}^{′} ) = ( R ( {r}_{i} ) , {R}^{- 1} ( {r}_{o} ) ) ,$$

and there is

$$( {r}_{o}^{′} , {r}_{i}^{′} ) = ( R ( {r}_{i} ) , R ( {r}_{o} ) ) when {R}^{- 1} ( {r}_{o} ) = R ( {r}_{o} ) .$$

$$Let G ( {r}_{i} , {r}_{o} ) = G ( {r}_{o}^{′} , {r}_{i}^{′} ) , and {δ}_{{x}_{k}} ( {r}_{o}^{′} ) = \int {G}_{k} ( {r}_{o}^{′} , {r}_{i}^{′} ) {δ}_{y} ( {r}_{i}^{′} ) d ( {r}_{i}^{′} )$$

is obtained again by introducing (rᵢ, rₒ) into δₓ_{ₖ} (rᵢ)=∫Gₖ(rᵢ, rₒ) δ_{y} (rₒ)d(rₒ), which is equivalent to providing δ_{y} at the input end of the system and propagating δ_{y} forward to the output end of the system. The equivalence relationship R⁻¹(rₒ)=R(rₒ) requires a rotation angle to be equal to R=π and an integer multiple of the symmetric rotation, i.e.,

$$π ≡ 0 ( mod \frac{2 π}{N} ) ,$$

the corresponding sufficient condition of which is that N is even.

Further, in an embodiment of the disclosure, to verify spatial symmetry and the accuracy of complex field measurements, a spatial symmetry conjugation method is adopted, where the transfer function is y=WM (x+B), x is the input, B is the input position, M is the trainable parameter matrix, W is the optical propagation matrix. The propagation process y=Wx needs to be analyzed. When the system is unitary and symmetric, W satisfies WW*=I, where I is the identity matrix and * denotes the conjugate operation. By propagating twice and using the conjugate of the first output as the input for the second propagation, y₂=Wy₁=W (Wx)*=x* is obtained.

In an embodiment of the disclosure, the amplitude of the original input may be restored through two propagations under symmetric and unitary constraints by the above method. At this time, when the original input may be recaptured at the second output, the symmetry of the system may be verified. Unitarily is a strict constraint imposed by losslessness of the system. In more general cases, the system may not always be unitary. For example, light may scatter laterally or be blocked in transverse directions. In such cases, the propagation matrix is represented as W=U(I−H), where U is a unitary matrix and H is a normalized difference between W and U·y₂ is represented as (I−H−UH*U*+HUH*U*) x*, let a be an eigenvalue of H with the maximum magnitude, and there is a L2 norm being ∥y₂−x*∥=|Hx*+UH*U*x*−HUH*U*x*∥≤3|α∥x*∥, which indicates the similarity of the output is bounded by 3|α|. Thus, even under non-unitary conditions, the similarity between the outputs and the inputs for two propagations may be used as a metric to verify the symmetry of the optical system.

From the above descriptions, it is demonstrated that the multi-layer perceptron may achieve high efficient and high-speed training of intelligent optical module layers via a fully forward training method. Consequently, the large model may realize high-speed, high-energy-efficiency training processes through high efficient training of intelligent optical module layers based on the fully forward online training method. The disclosure provides a novel, efficient, and green solution for future training of the large model.

Further, in an embodiment of the disclosure, after obtaining the third loss gradient of each network sub-layer in each optical module layer through the above steps, parameters of each network sub-layer may be updated based on the third loss gradient of each network sub-layer in each optical module layer. The above steps are repeated until the preset large model is converged, obtaining the target large model.

Further, in an embodiment of the disclosure, after obtaining the target large model through the above steps, the target large model may be applied to an intelligent question answering scenario. Specifically, in an embodiment of the disclosure, after the target large model obtains input question data, the target answer corresponding to the question data is obtained through the target large model.

In the method for training a large model for intelligent optical computing provided in embodiments of the disclosure, by integrating optical module layers into the multi-layer perceptron layer, the efficient acceleration of optical matrix operations may be realized using the optical module layers. This reduces computational delay and power consumption, and improves the training efficiency of the large model.

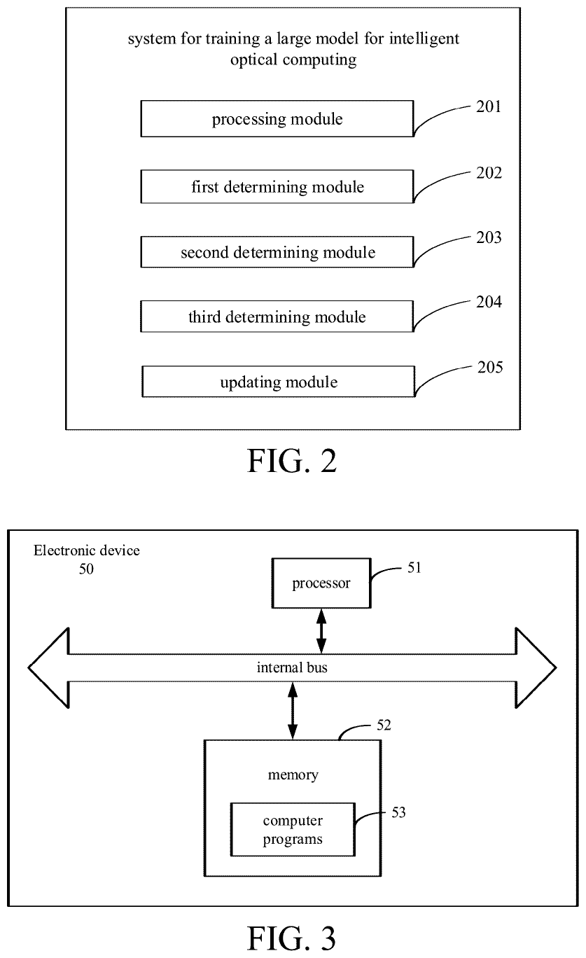

To implement the above embodiments, FIG. 2 is a block diagram illustrating a structure of a system for training a large model for intelligent optical computing provided in an embodiment of the disclosure. In embodiments of the disclosure, the system may be configured or integrated or included in an electronic device. The large model includes a multi-layer perceptron layer, the multi-layer perceptron layer includes at least one optical module layer. As shown in FIG. 2, the system includes: a processing module 201, a first determining module 202, a second determining module 203, a third determining module 204, and an updating module 205.

The processing module 201 is configured to obtain a training data set and obtain a prediction result by inputting data in the training data set into a preset large model.

The first determining module 202 is configured to determine, based on the prediction result and a real result, a target loss value via a target loss function.

The second determining module 203 is configured to determine a first loss gradient corresponding to the multi-layer perceptron layer by performing backpropagation based on the target loss value.

The third determining module 204 is configured to determine a second loss gradient of each optical module layer based on the first loss gradient.

The updating module 205 is configured to update parameters of each optical module layer based on the second loss gradient of each optical module layer, and obtain a target large model by repeating the above steps until the preset large model is converged.

In an embodiment of the disclosure, the processing module is specifically configured to: obtain input data of the multi-layer perceptron layer, and obtain first output data of each optical module layer by inputting the input data into each optical module layer in parallel; obtain second output data of the multi-layer perceptron layer by merging the first output data of each optical module layer; and input the second output data into a next network layer for the multi-layer perceptron layer, and determine an output result of a last network layer in the large model as the prediction result.

In an embodiment of the disclosure, the third determining module is configured to: determine a third loss gradient of each network sub-layer in each optical module layer based on the first loss gradient; and determine the third loss gradients of all network sub-layers in each optical module layer as the second loss gradient of each optical module layer.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another. A unit or module may be implemented purely by software, purely by hardware, or by a combination of hardware and software. In a pure software implementation, for example, the unit or module may include functionally related code blocks or software components, that are directly or indirectly linked together, so as to perform a particular function.

FIG. 3 is a block diagram illustrating an electronic device 50 according to an example embodiment of the present disclosure. The electronic device 50 includes a processor 51 and a memory 52. The memory 52 is configured to store executable instructions. The memory 52 includes computer programs 53. The processor 51 is configured to execute blocks of the above-mentioned method.

The processor 51 is configured to execute the computer programs 53 included in the memory 52. The processor 51 may be a central processing unit (CPU) or another a general-purpose processor, a digital signal processor (DSP), an application specific integrated circuit (ASIC), a field-programmable gate array (FPGA), another programmable logic device, a discrete gate, a transistor logic device, a discrete hardware component, and the like. The general-purpose processor may be a microprocessor or any conventional processor.

The memory 52 is configured to store computer programs related to the method. The memory 52 may include at least one type of storage medium. The storage medium includes a flash memory, a hard disk, a multimedia card, a card-type memory (such as, a SD (secure digital) or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, etc. The device may cooperate with a network storage device that performs a storage function of the memory by a network connection. The memory 52 may be an internal storage unit of the electronic device 50, such as a hard disk or a memory of the electronic device 50. The memory 52 may also be an external storage device of the electronic device 50, such as a plug-in hard disk, a smart media card (SMC), a secure digital (SD) card, a flash card, disposed on the electronic device 50. Further, the memory 52 may also include both the internal storage unit of the electronic device 50 and the external storage device. The memory 52 is configured to store the computer program 53 and other programs and data required by the device. The memory 52 may also be configured to temporarily store data that has been output or will be output.

The various embodiments described herein may be implemented by using the computer readable medium such as computer software, hardware, or any combination thereof. For a hardware implementation, embodiments described herein may be implemented by using at least one of: an application specific integrated circuit (ASIC), a digital signal processor (DSP), a digital signal processing device (DSPD), a programmable logic device (PLD), a field programmable gate array (FPGA), a processor, a controller, a microcontroller, a microprocessor, and an electronic unit designed to perform the functions described herein. For a software implementation, an implementation such as a procedure or a function may be implemented with a separate software module that allows at least one function or operation to be performed. Software codes may be implemented by a software application (or program) written in any suitable programming language, and the software codes may be stored in the memory and executed by the controller.

The electronic device 50 includes, but is not limited to, a mobile terminal, an ultra-mobile personal computer device, a server, and other electronic device with a computing function. (1) The mobile terminal is characterized by having a function of mobile communication and aiming at providing a voice and data communication. Such mobile terminal includes a smart phone (such as iPhone), a multimedia phone, a functional phone, and a low-end phone. (2) The ultra-mobile personal computer device belongs to a category of personal computer, which has a computing and processing function, and generally has a feature of mobile Internet access. Such terminal includes a PDA (personal digital assistant), a MID (mobile Internet device) and a UMPC (ultra mobile personal computer) devices, such as an iPad. (3) The server provides a computing service. A composition of the server includes a processor, a hard disk, a memory, a system bus, etc. The server is similar to the general computer architecture, but because the server only provides a highly reliable service, it requires a higher processing capacity, stability, reliability, security, scalability and manageability. (4) Other electronic device with the computing function may include, but be not limited to, the processor 51 and the memory 52. It may be understood by the skilled in the art that, FIG. 4 is merely an example of the electronic device 50, and does not constitute a limitation of the electronic device 50. The electronic device 50 may include more or less components than illustrated, some combined components, or different components. For example, the electronic device may also include an input device, an output device, a network access device, a bus, a camera device, etc.

The implementation procedure of the functions of each unit in the above device may refer to the implementation procedure of the corresponding actions in the above method, which is not elaborated here.

In some embodiment, there is also provided a storage medium including instructions, such as the memory 52 including instructions. The above instructions may be executed by the processor 51 of the electronic device 50 to perform the above method. In some embodiments, the storage medium may be a non-transitory computer readable storage medium. For example, the non-transitory computer readable storage medium may include a ROM, a RAM, a compact disc read-only memory (CD-ROM), a magnetic tape, a floppy disk, optical data storage device, etc.

A non-transitory computer readable storage medium is provided. When instructions stored in the storage medium are executed by an electronic device, the electronic device is enabled to execute the above method.

In some embodiments, there is also provided a computer program product including executable program codes. The program codes are configured to execute any of the above embodiments of the method when executed by the above electronic device.

In a technical solution of the disclosure, processing including collection, storage, use, shaping, transmission, provision and disclosure of the personal information of the user is in compliance with the provisions of relevant laws and regulations, and do not violate public order and moral.

It should be noted that personal information from users should be collected for a legitimate and reasonable purpose, and should not be shared or sold beyond these legitimate uses. In addition, such collection/sharing should be carried out after receiving an informed consent from the user, including but not limited to, notifying the user to read a user agreement/user notification and sign an agreement/authorization that includes an authorization of relevant user information before using this function. In addition, necessary steps should be taken to safeguard an access to such personal information data, and to ensure that others who have the right to access the personal information data comply with a privacy policy and procedures.

The disclosure is expected to provide an implementation plan for the user to selectively block the use or access of the personal information data, that is, the disclosure is intended to provide hardware and/or software to prevent or block access to the personal information data. Once the personal information data is no longer needed, limiting data collection and deleting data may minimize risks. In addition, when applicable, a personal identifier should be removed from the personal information to protect a privacy of the user.

Acquisition, transmission, storage, use, and processing of data in the technical solution of the disclosure comply with relevant regulations in national laws.

It should be noted that in the embodiments of the disclosure, some software, components, models, and other existing solutions in the industry may be mentioned, which should be considered as exemplary. The purpose is only to illustrate a feasibility of the technical solution in the application, but it does not mean that the applicant has already or necessarily used the solution.

In the descriptions of the above embodiments, reference throughout this specification to “an embodiment,” “some embodiments,” “an example,” “a specific example,” or “some examples,” means that a particular feature, structure, material, or characteristic described in combination with the embodiment or example is included in at least one embodiment or example of the disclosure. The appearances of the above phrases in various places throughout this specification are not necessarily referring to the same embodiment or example of the disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply the relative importance or implicitly specify the number of technical features indicated. Therefore, the feature defined with “first” and “second” may explicitly or implicitly include at least one such feature. In the description of the disclosure, “a plurality of” means at least two, for example, two or three, unless specified otherwise.

Any process or method described in a flowchart or described herein in other ways may be understood to include one or more modules, segments or portions of codes of executable instructions for achieving specific logical functions or steps in the process, the scope of a preferred embodiment of the disclosure includes other implementations, and functions may be performed in a substantially simultaneous order or a reverse order in addition to the order shown or discussed depending on the function involved, which should be understood by those skilled in the art.

The logic and/or step described in other manners herein or shown in the flowchart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a RAM, a ROM, an EPROM or a flash memory, an optical fiber device and a portable CD-ROM. In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It may be understood by those skilled in the art that all or a part of the steps carried by the method in the above-described embodiments may be completed by relevant hardware instructed by a program. The program may be stored in a computer readable storage medium. When the program is executed, one step or a combination of the steps of the method in the above-described embodiments may be completed.

In addition, individual functional units in the embodiments of the disclosure may be integrated in one processing module or may be physically separated, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The storage medium mentioned above may be ROMs, magnetic disks or CD, etc. Although explanatory embodiments have been shown and described, it would be appreciated by those skilled in the art that the above embodiments are exemplary and are not to be construed as limiting the disclosure, and changes, modifications, alternatives, and modifications can be made in the embodiments without departing from scope of the disclosure.

What is claimed is:

1. A method for training a large model based on intelligent optical computing, performed by an electronic device, the method comprising:
obtaining a training data set and obtaining a prediction result by inputting data in the training data set into a preset large model, wherein the preset large model comprises a multi-layer perceptron layer, and the multi-layer perceptron layer comprises at least one optical module layer;
determining, based on the prediction result and a real result, a target loss value via a target loss function;
determining a first loss gradient corresponding to the multi-layer perceptron layer by performing backpropagation based on the target loss value;
determining a second loss gradient of each optical module layer based on the first loss gradient;
updating parameters of each optical module layer based on the second loss gradient of each optical module layer; and
obtaining a target large model by repeating the above steps until the preset large model is converged.

2. The method according to claim 1, wherein obtaining the prediction result by inputting the data in the training data set into the preset large model comprises:
obtaining input data of the multi-layer perceptron layer, and obtaining first output data of each optical module layer by inputting the input data into each optical module layer in parallel;
obtaining second output data of the multi-layer perceptron layer by merging the first output data of each optical module layer; and
inputting the second output data into a next network layer for the multi-layer perceptron layer, and determining an output result of a last network layer in the large model as the prediction result.

3. The method according to claim 1, wherein each optical module layer comprises at least one network sub-layer, and determining the second loss gradient of each optical module layer based on the first loss gradient comprises:
determining a third loss gradient of each network sub-layer in each optical module layer based on the first loss gradient; and
determining the third loss gradients of all network sub-layers in each optical module layer as the second loss gradient of each optical module layer.

4. The method according to claim 3, wherein updating the parameters of each optical module layer based on the second loss gradient of each optical module layer comprises:
updating parameters of each network sub-layer based on the third loss gradient of each network sub-layer in each optical module layer.

5. The method according to claim 3, wherein determining the third loss gradient of each network sub-layer in each optical module layer based on the first loss gradient comprises:
determining a fourth loss gradient of each network sub-layer in each optical module layer by differentiating the first loss gradient based on a chain rule; and
obtaining the third loss gradient of each network sub-layer in each optical module layer by processing the fourth loss gradient of each network sub-layer based on Lorentz reciprocity.

6. An electronic device, comprising:
at least one processor; and
a memory communicatively coupled to the at least one processor and storing instructions executable by the at least one processor;
wherein, when the instructions are executed by the at least one processor, the at least one processor is configured to:
obtain a training data set and obtaining a prediction result by inputting data in the training data set into a preset large model, wherein the preset large model comprises a multi-layer perceptron layer, and the multi-layer perceptron layer comprises at least one optical module layer;
determine, based on the prediction result and a real result, a target loss value via a target loss function;
determine a first loss gradient corresponding to the multi-layer perceptron layer by performing backpropagation based on the target loss value;
determine a second loss gradient of each optical module layer based on the first loss gradient;
update parameters of each optical module layer based on the second loss gradient of each optical module layer; and
obtain a target large model by repeating the above steps until the preset large model is converged.

7. The electronic device according to claim 6, wherein the at least one processor is further configured to:
obtain input data of the multi-layer perceptron layer, and obtain first output data of each optical module layer by inputting the input data into each optical module layer in parallel;
obtain second output data of the multi-layer perceptron layer by merging the first output data of each optical module layer; and
input the second output data into a next network layer for the multi-layer perceptron layer, and determine an output result of a last network layer in the large model as the prediction result.

8. The electronic device according to claim 6, wherein each optical module layer comprises at least one network sub-layer, and the at least one processor is further configured to:
determine a third loss gradient of each network sub-layer in each optical module layer based on the first loss gradient; and
determine the third loss gradients of all network sub-layers in each optical module layer as the second loss gradient of each optical module layer.

9. The electronic device according to claim 8, wherein the at least one processor is further configured to:
update parameters of each network sub-layer based on the third loss gradient of each network sub-layer in each optical module layer.

10. The electronic device according to claim 8, wherein the at least one processor is further configured to:
determine a fourth loss gradient of each network sub-layer in each optical module layer by differentiating the first loss gradient based on a chain rule; and
obtain the third loss gradient of each network sub-layer in each optical module layer by processing the fourth loss gradient of each network sub-layer based on Lorentz reciprocity.

11. A non-transitory computer-readable storage medium, storing computer-executable instructions which, when executed by a processor, enable a method for training a large model based on intelligent optical computing to be implemented, the method comprising:
obtaining a training data set and obtaining a prediction result by inputting data in the training data set into a preset large model, wherein the preset large model comprises a multi-layer perceptron layer, and the multi-layer perceptron layer comprises at least one optical module layer;
determining, based on the prediction result and a real result, a target loss value via a target loss function;
determining a first loss gradient corresponding to the multi-layer perceptron layer by performing backpropagation based on the target loss value;
determining a second loss gradient of each optical module layer based on the first loss gradient;
updating parameters of each optical module layer based on the second loss gradient of each optical module layer; and
obtaining a target large model by repeating the above steps until the preset large model is converged.

12. The storage medium according to claim 11, wherein obtaining the prediction result by inputting the data in the training data set into the preset large model comprises:
obtaining input data of the multi-layer perceptron layer, and obtaining first output data of each optical module layer by inputting the input data into each optical module layer in parallel;
obtaining second output data of the multi-layer perceptron layer by merging the first output data of each optical module layer; and
inputting the second output data into a next network layer for the multi-layer perceptron layer, and determining an output result of a last network layer in the large model as the prediction result.

13. The storage medium according to claim 11, wherein each optical module layer comprises at least one network sub-layer, and determining the second loss gradient of each optical module layer based on the first loss gradient comprises:
determining a third loss gradient of each network sub-layer in each optical module layer based on the first loss gradient; and
determining the third loss gradients of all network sub-layers in each optical module layer as the second loss gradient of each optical module layer.

14. The storage medium according to claim 13, wherein updating the parameters of each optical module layer based on the second loss gradient of each optical module layer comprises:
updating parameters of each network sub-layer based on the third loss gradient of each network sub-layer in each optical module layer.

15. The storage medium according to claim 13, wherein determining the third loss gradient of each network sub-layer in each optical module layer based on the first loss gradient comprises:
determining a fourth loss gradient of each network sub-layer in each optical module layer by differentiating the first loss gradient based on a chain rule; and
obtaining the third loss gradient of each network sub-layer in each optical module layer by processing the fourth loss gradient of each network sub-layer based on Lorentz reciprocity.
